(19) United States
(12) Patent Application Publication
(10) Pub. No.: US 2017/0270851 A1
(43) Pub. Date: Sep. 21, 2017

(54) SHIFT REGISTER, GATE DRIVER CIRCUIT AND DISPLAY APPARATUS

(71) Applicant: Boe Technology Group Co., Ltd., Beijing (CN)

(72) Inventors: Guangliang Shang, Beijing (CN); Seungwoo Han, Beijing (CN); Zhihe Jin, Beijing (CN); Mingfu Han, Beijing (CN); Xing Yao, Beijing (CN); Haoling Zheng, Beijing (CN); Yunsil IM, Beijing (CN); Seungmin Lee, Beijing (CN); Haijun Qiu, Beijing (CN); Jungmok Jun, Beijing (CN); Xue Dong, Beijing (CN)

(21) Appl. No.: 15/503,051

(22) PCT Filed: Aug. 4, 2016
(86) PCT No.: PCT/CN16/93182

§ 371 Date: Feb. 10, 2017

(30) Foreign Application Priority Data
Nov. 4, 2015 (CN) 201510744515.7

(51) Int. Cl. G09G 3/20

(52) U.S. Cl. CPC G09G 3/2092; G09G 2310/0286; G09G 2310/08; G09G 3/3266

(57) ABSTRACT

A shift register is disclosed including an input module, an output module, a first reset module, a first pull-down module and a second pull-down module. The first pull-down module is configured to supply a reference signal to a first node and an output terminal in response to an active level of a first control signal. The second pull-down module is configured to supply the reference signal to the first node and the output terminal in response to an active level of a second control signal. The active levels of the first control signal and the second control signal occur alternately. Also disclosed are a gate driver circuit and a display apparatus.

### TECHNICAL FIELD

The present disclosure relates to the field of display technologies, and particularly to a shift register, a gate driver circuit and a display apparatus.

### BACKGROUND

An active matrix display apparatus such as a liquid crystal display includes a data driver, a gate driver and a display panel. The display panel has a pixel array to which data voltages are supplied by the data driver and gate voltages by the gate driver.

The gate driver generally includes a plurality of cascaded shift registers. To prevent the shift registers from outputting noises during a non-operation period of time, a pull-down module is usually provided in each of the shift registers, which contains a de-noise transistor for removing the noises at an output terminal of the shift register. However, since the pull-down module is kept in operation during the non-operation period of time of the shift register, the de-noise transistor tends to fail in a short time and hence lose de-noise capability, resulting in a misoperation of the shift register. This reduces the working life of the shift register.

### SUMMARY

In view of this, embodiments of the present disclosure provide a shift register, a gate driver circuit and a display apparatus, which seek to alleviate or eliminate at least one of the problems as described above. According to a first aspect of the present disclosure, a shift register is provided which includes an input module configured to set a level of a first node to a first level in response to an active level of an input signal from an input terminal, an output module configured to supply a clock signal from a clock signal terminal to an output terminal in response to the level of the first node being the first level, a first reset module configured to supply a reference signal from a reference signal terminal to the first node in response to an active level of a first reset signal from a first reset signal terminal, a first pull-down module configured to supply the reference signal from the reference signal terminal to a second node in response to the level of the first node being the first level, and to set a level of the second node to the first level and supply the reference signal from the reference signal terminal to the first node and the output terminal in response to an active level of a first control signal from a first control signal terminal, and a second pull-down module configured to supply the reference signal from the reference signal terminal to a third node in response to the level of the first node being the first level, and to set a level of the third node to the first level and supply the reference signal from the reference signal terminal to the first node and the output terminal in response to an active level of a second control signal from a second control signal terminal. The active levels of the first control signal and the second control signal occur alternately.

In some embodiments, the input module comprises a first transistor having a gate and a source jointly connected to the input terminal, and a drain connected to the first node.

In some embodiments, the first reset module comprises a second transistor having a gate connected to the first reset signal terminal, a source connected to first node, and a drain connected to the reference signal terminal.

In some embodiments, the output module comprises a third transistor having a gate connected to the first node, a source connected to the clock signal terminal, and a drain connected to the output terminal.

In some embodiments, the output module further comprises a capacitor connected between the gate and drain of the third transistor.

In some embodiments, the first pull-down module comprises: a fourth transistor having a gate and a source jointly connected to the first control signal terminal, and a drain connected to a fourth node; a fifth transistor having a gate connected to the fourth node, a source connected to the first control signal terminal, and a drain connected to the second node; a sixth transistor having a gate connected to the first node, a source connected to the fourth node, and a drain connected to the reference signal terminal; a seventh transistor having a gate connected to the first node, a source connected to the second node, and a drain connected to the reference signal terminal; an eighth transistor having a gate connected to the second node, a source connected to the first node, and drain connected to the reference signal terminal; and a ninth transistor having a gate connected to the second node, a source connected to the output terminal, and a drain connected to the reference signal terminal.

In some embodiments, the second pull-down module comprises: a tenth transistor having a gate and a source jointly connected to the second control signal terminal, and a drain connected to a fifth node; an eleventh transistor having a gate connected to the fifth node, a source connected to the second control signal terminal, and a drain connected to the third node; a twelfth transistor having a gate connected to the first node, a source connected to the fifth node, and a drain connected to the reference signal terminal; a thirteenth transistor having a gate connected to the first node, a source connected to the third node, and a drain connected to the reference signal terminal; a fourteenth transistor having a gate connected to the third node, a source connected to the first node, and a drain connected to the reference signal terminal; and a fifteenth transistor having a gate connected to the third node, a source connected to the output terminal, and a drain connected to the reference signal terminal.

In some embodiments, the shift register further comprises a pull-down reset module configured to supply the reference signal from the reference signal terminal to the second node, the third node, the fourth node and the fifth node in response to the active level of the input signal from the input terminal.

In some embodiments, the pull-down reset module comprises: a sixteenth transistor having a gate connected to the input terminal, a source connected to the second node, and a drain connected to the reference signal terminal; a seventeenth transistor having a gate connected to the input terminal, a source connected to the third node, and a drain connected to the reference signal terminal; an eighteenth transistor having a gate connected to the input terminal, a source connected to the fourth node, and a drain connected to the reference signal terminal; and a nineteenth transistor having a gate connected to the input terminal, a source connected to the fifth node, and a drain connected to the reference signal terminal.

In some embodiments, the shift register further comprises a second reset module configured to supply the reference signal from the reference signal terminal to the output terminal in response to an active level of a second reset signal from a second reset signal terminal.

In some embodiments, the shift register further comprises a pull-down reset module configured to supply the reference signal from the reference signal terminal to the second node, the third node, the fourth node and the fifth node in response to the active level of the input signal from the input terminal.

In some embodiments, the pull-down reset module comprises: a sixteenth transistor having a gate connected to the input terminal, a source connected to the second node, and a drain connected to the reference signal terminal; a seventeenth transistor having a gate connected to the input terminal, a source connected to the third node, and a drain connected to the reference signal terminal; an eighteenth transistor having a gate connected to the input terminal, a source connected to the fourth node, and a drain connected to the reference signal terminal; and a nineteenth transistor having a gate connected to the input terminal, a source connected to the fifth node, and a drain connected to the reference signal terminal.

In some embodiments, the shift register further comprises a second reset module configured to supply the reference signal from the reference signal terminal to the output terminal in response to an active level of a second reset signal from a second reset signal terminal.

In some embodiments, the second reset module comprises a twentieth transistor having a gate connected to the second reset signal terminal, a source connected to the output terminal, and a drain connected to the reference signal terminal.

In some embodiments, the first reset signal terminal and the second reset signal terminal are connected to each other.

In some embodiments, the first reset signal is delayed by 0 to ½ clock period with respect to the second reset signal.

According to a second aspect of the present disclosure, a gate driver circuit is provided which includes a plurality of cascaded shift registers, each of the shift registers having a respective output terminal, an input terminal, a first reset signal terminal and a second reset signal terminal.

In some embodiments, the first reset signal terminal and the second reset signal terminal are connected to each other. The output terminal of the n-th shift register is connected to the input terminal of the (n+m)th shift register, and the output terminal of the n-th shift register is connected to the first reset signal terminal and second reset signal terminal of the (n−m)th shift register. m is an integer larger than or equal to 1, and n is an integer larger than m.

In some embodiments, the first reset signal terminal and the second reset signal terminal are separate terminals. The output terminal of the n-th shift register is connected to the input terminal of the (n+m)th shift register, and the output terminal of the n-th shift register is connected to the first reset signal terminal of the (n−m−1)th shift register and the second reset signal terminal of the (n−m)th shift register. m is an integer larger than or equal to 1, and n is an integer larger than m.

In some embodiments, the first reset signal terminal and the second reset signal terminal are separate terminals. The output terminal of the n-th shift register is connected to the input terminal of the (n+m)th shift register, and the output terminal of the n-th shift register is connected to the first reset signal terminal of the (n−m)th shift register and the second reset signal terminal of the (n−m+1)th shift register. m is an integer larger than 1, and n is an integer larger than m.

According to a second aspect of the present disclosure, a display apparatus is provided which includes any one of the gate driver circuits as described above.

These and other aspects of the present disclosure will be apparent from and elucidated with reference to the embodiment(s) described hereinafter.

### BRIEF DESCRIPTION OF THE DRAWINGS

FIG. 1a is a block diagram of a shift register according to an embodiment of the present disclosure;

FIG. 1b is a schematic diagram of signals of a shift register according to an embodiment of the present disclosure;

FIGS. 2a to 2d are schematic diagrams of example circuits of the shift register of FIG. 1a;

FIG. 3 is another block diagram of a shift register according to an embodiment of the present disclosure;

FIGS. 4a and 4b are schematic diagrams of example circuits of the shift register of FIG. 3;

FIGS. 5a and 5b are schematic diagrams of further example circuits of a shift register according to an embodiment of the present disclosure;

FIG. 6a is a timing diagram of the shift register circuit of FIG. 4a;

FIG. 6b is a timing diagram of the shift register circuit of FIG. 5a;

FIG. 7 is a schematic diagram of a gate driver circuit according to an embodiment of the present disclosure;

FIG. 8 is another schematic diagram of a gate driver circuit according to an embodiment of the present disclosure;

FIG. 9 is yet another schematic diagram of a gate driver circuit according to an embodiment of the present disclosure; and

FIG. 10 is a schematic diagram of a display apparatus according to an embodiment of the present disclosure.

### DETAILED DESCRIPTION

The shift register, gate driver circuit and display apparatus according to embodiments of the present disclosure will be described in detail in combination with the accompanying drawings.

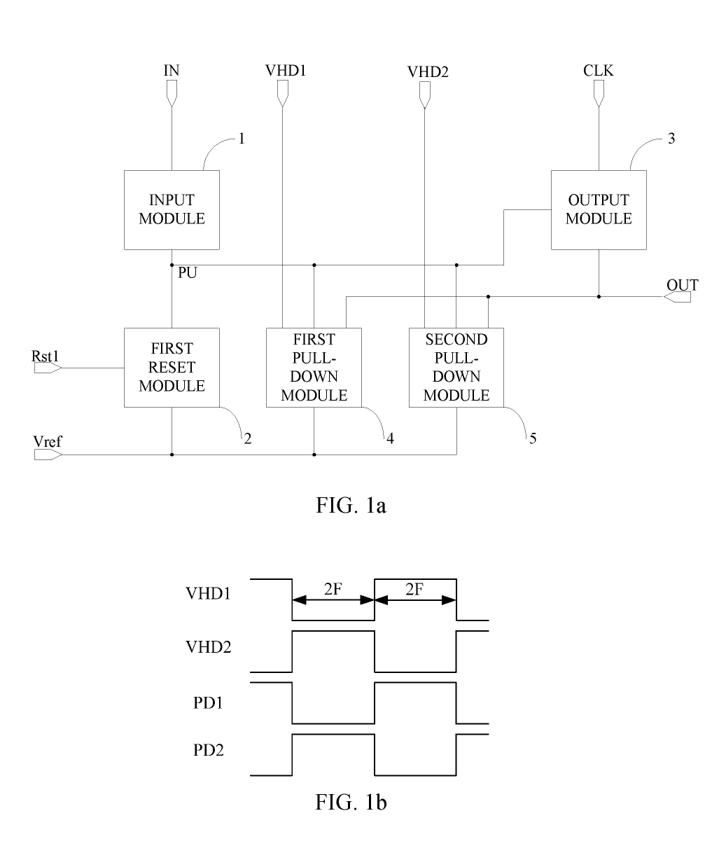

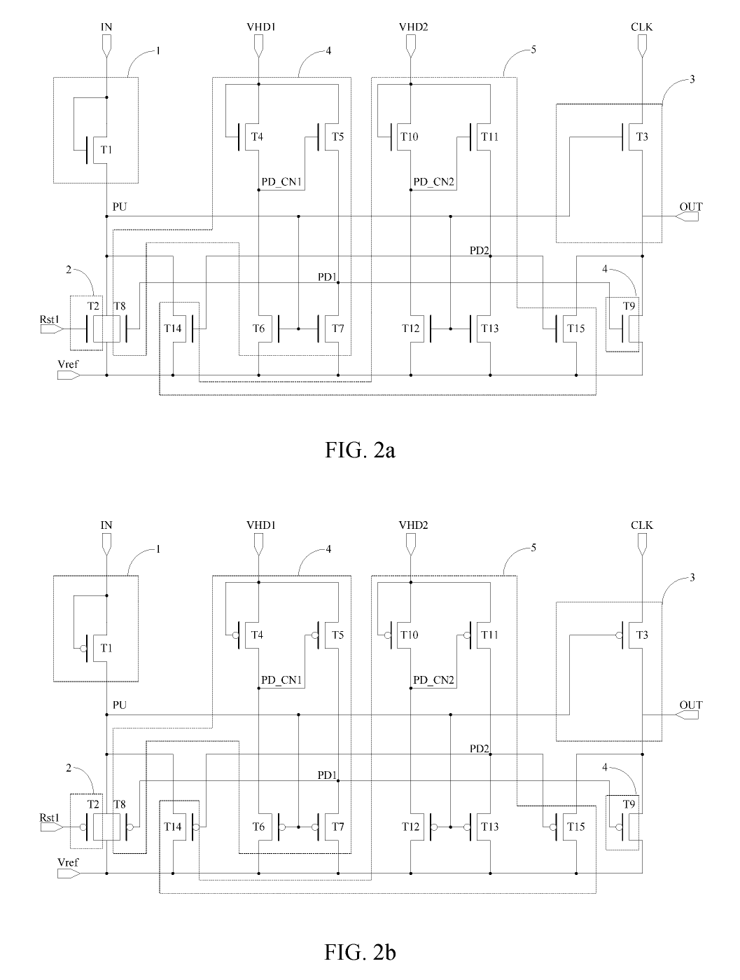

FIG. 1a is a block diagram of a shift register according to an embodiment of the present disclosure. As shown in FIG. 1a, the shift register includes an input module 1, a first reset module 2, an output module 3, a first pull-down module 4 and a second pull-down module 5.

The input module 1 has a first terminal connected to an input terminal IN and a second terminal connected to a first node PU. The input module 1 is configured to set a level of the first node PU to a first level in response to an active level of an input signal from the input terminal IN.

The output module 3 has a first terminal connected to a clock signal terminal CLK, a second terminal connected to the first node PU, and a third terminal connected to an output terminal OUT. The output module 3 is configured to supply a clock signal from the clock signal terminal CLK to the output terminal OUT in response to the level of the first node PU being the first level.

The first reset module 2 has a first terminal connected to a reference terminal Vref, a second terminal connected to a first reset signal terminal Rst1, and a third terminal connected to the first node PU. The first reset module 2 is configured to supply a reference signal from the reference signal terminal Vref to the first node PU in response to an active level of a first reset signal from the first reset signal terminal Rst1 .

The first pull-down module 4 has a first terminal connected to a first control signal terminal VHD1, a second terminal connected to the reference signal terminal Vref, a third terminal connected to the first node PU, a fourth terminal connected to a second node PD1 (not shown in FIG. 1a), and a fifth terminal connected to the output terminal OUT. The first pull-down module 4 is configured to supply the reference signal from the reference signal terminal Vref to the second node PD1 in response to the level of the first node PU being the first level, and to set a level of the second node PD1 to the first level and supply the reference signal from the reference signal terminal Vref to the first node PU and the output terminal OUT in response to an active level of a first control signal from the first control signal terminal VHD1.

The second pull-down module 5 has a first terminal connected to a second control signal terminal VHD2, a second terminal connected to the reference signal terminal Vref, a third terminal connected to the first node PU, a fourth terminal connected to a third node PD2 (not shown in FIG. 1a), and a fifth terminal connected to the output terminal OUT. The second pull-down module 5 is configured to supply the reference signal from the reference signal terminal Vref to the third node PD2 in response to the level of the first node PU being the first level, and to set a level of the third node PD2 to the first level and supply the reference signal from the reference signal terminal Vref to the first node PU and the output terminal OUT in response to an active level of a second control signal from the second control signal terminal VHD2.

The active levels of the first control signal and the second control signal occur alternately. In some embodiments, the input signal, the first reset signal, the first control signal and the second control signal are active-high signals, the first level is a high level, and the reference signal is a low level signal. Alternatively, the input signal, the first reset signal, the first control signal and the second control signal are active-low signals, the first level is a low level, and the reference signal is a high level signal.

FIG. 1b is a schematic diagram of signals of a shift register according to an embodiment of the present disclosure. As shown in FIG. 1b, the active levels of the first control signal supplied to the first control signal terminal VHD1 and the second control signal supplied to the second control signal terminal VHD2 occur alternately, such that the levels of the second node PD1 and the third node PD2 are set to the first level alternately. As will be described later, this allows part of the components of the first pull-down module 4 and the second pull-down module 5 to operate alternately, thus reducing their respective actual operating time. This can prolong the working life of the shift register.

In embodiments, the first control signal and the second control signal may each be a square wave with a duty ratio of 50%. For example, the periods of the first control signal and the second control signal may be the same as or an integral multiple of that of the clock signal input via the clock signal terminal CLK. In an embodiment where a plurality of the shift registers form a gate driver circuit of a display panel, the periods of the first and second control signal may be an integral multiple of the frame period. In the example as shown in FIG. 1b, the periods of the first and second control signal are each four frame periods, wherein the low level lasts two frame periods (2F), and the high level lasts two frame periods (2F).

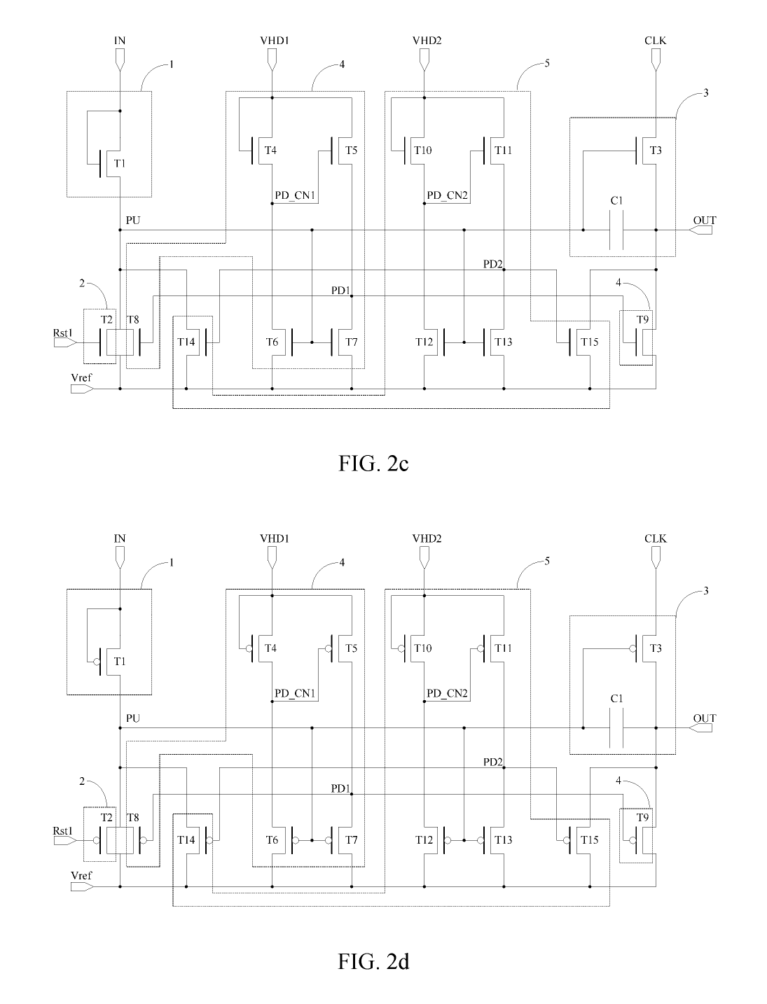

Example circuits of the shift register of FIG. 1a are shown in FIGS. 2a to 2d, although other embodiments are possible. The transistors are shown in FIGS. 2a and 2c as N-type transistors, and in FIGS. 2b and 2d as P-type transistors.

The input module 1 includes a first transistor T1. The first transistor T1 has a gate and a source jointly connected to the input terminal IN, and a drain connected to the first node PU.

The first reset module 2 includes a second transistor T2. The second transistor T2 has a gate connected to the first reset signal terminal Rst1, a source connected to first node PU, and a drain connected to the reference signal terminal Vref.

The output module 3 includes a third transistor T3. The third transistor T3 has a gate connected to the first node PU, a source connected to the clock signal terminal CLK, and a drain connected to the output terminal OUT. In the examples as shown in FIGS. 2c and 2d, the output module 3 further includes a capacitor C1 connected between the gate and drain of the third transistor T3. When the first node PU is floated, the level of the first node PU can be further pulled up or down by the bootstrap of the capacitor C1, thus ensuring that the output of the shift register is correct. Moreover, the arrangement of the capacitor C1 facilitates reduction of the noises at the first node PU and the output terminal OUT.

The first pull-down module 4 includes a fourth transistor T4, a fifth transistor T5, a sixth transistor T6, a seventh transistor T7, an eighth transistor T8 and a ninth transistor T9. For ease of illustration, the components of the first pull-down module 4 are shown in two separate dotted boxes.

The fourth transistor T4 has a gate and a source jointly connected to the first control signal terminal VHD1, and a drain connected to a fourth node PD_CN1. The fifth transistor T5 has a gate connected to the fourth node PD_CN1, a source connected to the first control signal terminal VHD1, and a drain connected to the second node PD1. The sixth transistor T6 has a gate connected to the first node PU, a source connected to the fourth node PD_CN1, and a drain connected to the reference signal terminal Vref. The seventh transistor T7 has a gate connected to the first node PU, a source connected to the second node PD1, and a drain connected to the reference signal terminal Vref. The eighth transistor T8 has a gate connected to the second node PD1, a source connected to the first node PU, and drain connected to the reference signal terminal Vref. The ninth transistor T9 has a gate connected to the second node PD1, a source connected to the output terminal OUT, and a drain connected to the reference signal terminal Vref.

The second pull-down module 5 includes a tenth transistor T10, an eleventh transistor T11, a twelfth transistor T12, a thirteenth transistor T13, a fourteenth transistor T14 and a fifteenth transistor T15.

The tenth transistor T10 has a gate and a source jointly connected to the second control signal terminal VHD2, and a drain connected to a fifth node PD_CN2. The eleventh transistor T11 has a gate connected to the fifth node PD_CN2, a source connected to the second control signal terminal VHD2, and a drain connected to the third node PD2. The twelfth transistor T12 has a gate connected to the first node PU, a source connected to the fifth node PD_CN2, and a drain connected to the reference signal terminal Vref. The thirteenth transistor T13 has a gate connected to the first node PU, a source connected to the third node PD2, and a drain connected to the reference signal terminal Vref. The fourteenth transistor T14 has a gate connected to the third node PD2, a source connected to the first node PU, and a drain connected to the reference signal terminal Vref. The fifteenth transistor T15 has a gate connected to the third node PD2, a source connected to the output terminal OUT, and a drain connected to the reference signal terminal Vref.

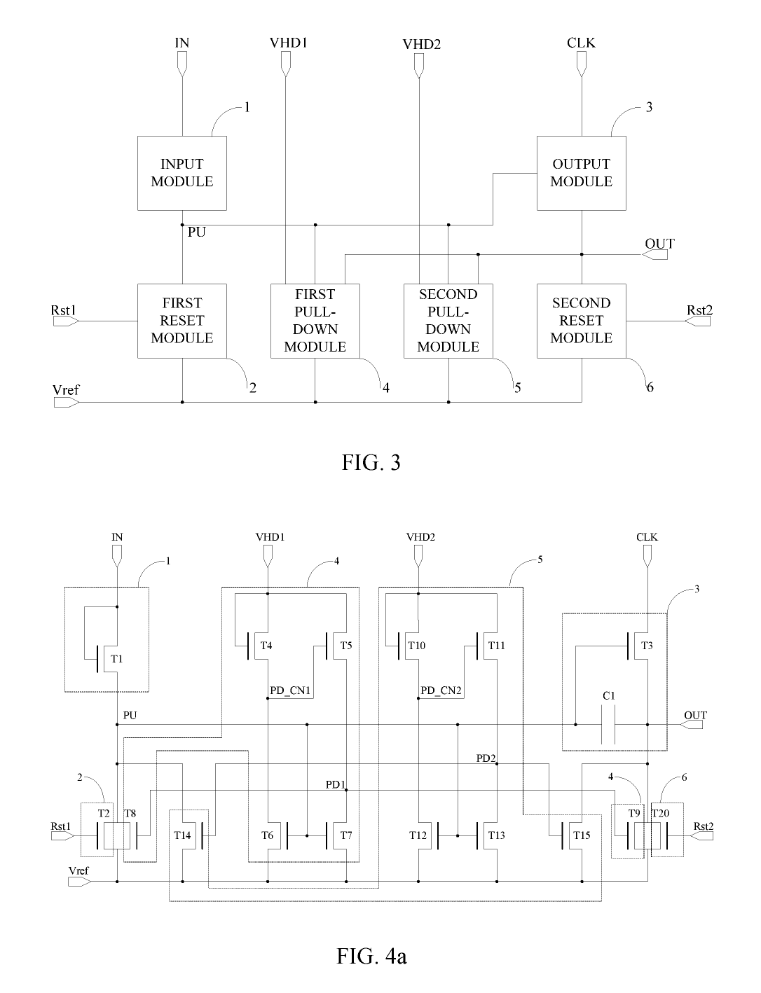

FIG. 3 is another block diagram of a shift register according to an embodiment of the present disclosure. As compared with the embodiment of FIG. 1a, the shift register as shown in FIG. 3 further includes a second reset module 6.

The second reset module 6 has a first terminal connected to a second reset signal terminal Rst2, a second terminal connected to the reference signal terminal Vref, and a third terminal connected to the output terminal OUT. The second reset module 6 is configured to supply the reference signal from the reference signal terminal Vref to the output terminal OUT in response to an active level of a second reset signal from the second reset signal terminal Rst2.

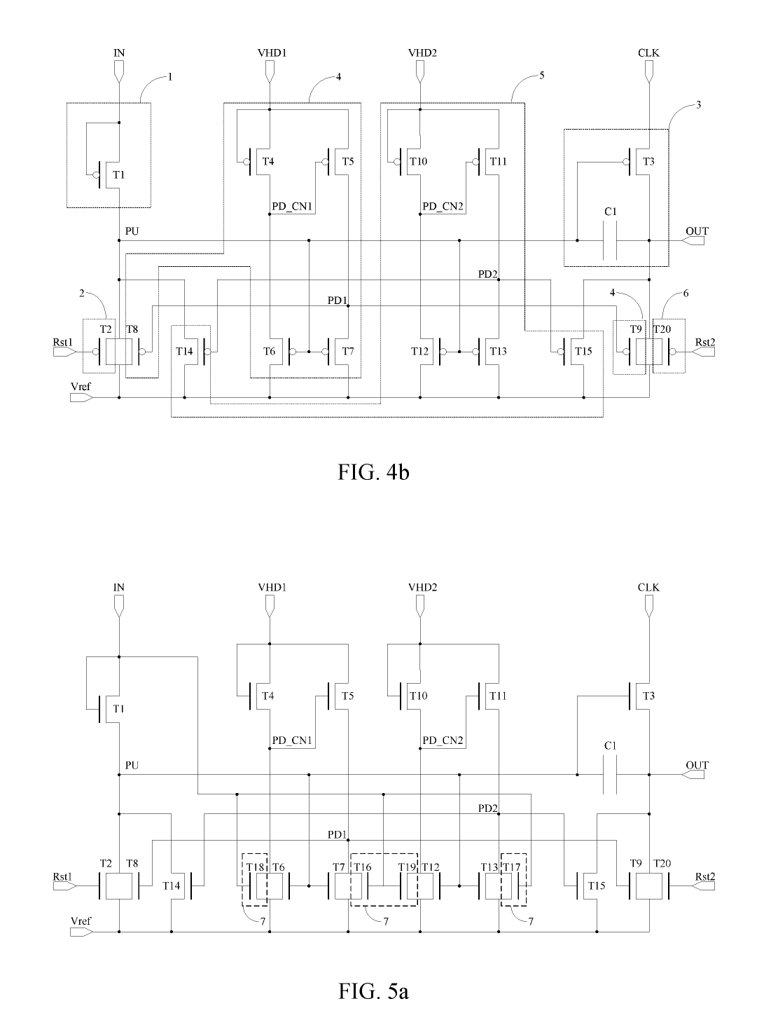

Example circuits of the shift register of FIG. 3 are shown in FIGS. 4a and 4b, although other embodiments are possible. As shown in FIGS. 4a and 4b, the second reset module 6 includes a twentieth transistor T20.

The twentieth transistor T20 has a gate connected to the second reset signal terminal Rst2, a source connected to the output terminal OUT, and a drain connected to the reference signal terminal Vref. The twentieth transistor T20 is shown in FIG. 4a as an N-type transistor, and in FIG. 4b as a P-type transistor.

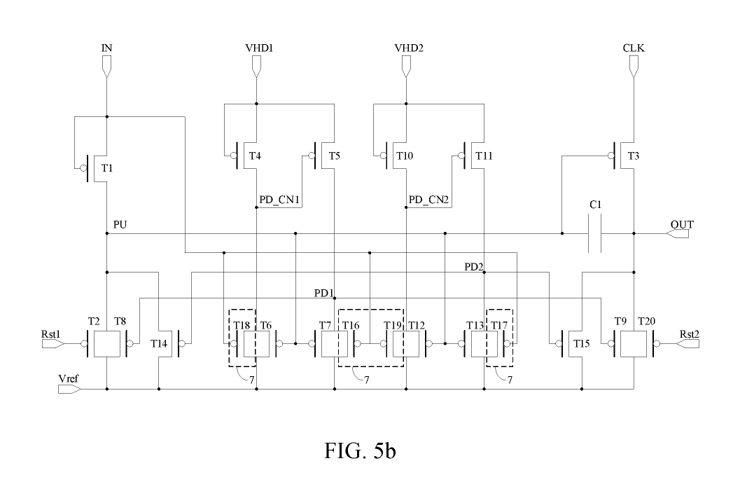

FIGS. 5a and 5b are schematic diagrams of further example circuits of a shift register according to an embodiment of the present disclosure. As shown in FIGS. 5a and 5b, the shift register further includes a pull-down reset module 7. For ease of illustration, the components of the pull-down reset module 7 are shown in three separate dotted boxes.

The pull-down reset module 7 has a first terminal connected to the input terminal IN, a second terminal connected to the reference signal terminal Vref, a third terminal connected to the second node PD1, a fourth terminal connected to the third node PD2, a fifth terminal connected to the fourth node PD_CN1, and a sixth terminal connected to the fifth node PD_CN2. The pull-down reset module 7 is configured to supply the reference signal from the reference signal terminal Vref to the second node PD1, the third node PD2, the fourth node PD_CN1 and the fifth node PD_CN2 in response to the active level of the input signal from the input terminal IN. The arrangement of the pull-down reset module 7 can reduce the reset time of the individual nodes, and thus the reset time of the output terminal OUT. This facilitates improvement of the driving capability of the shift register.

In the examples of FIGS. 5a and 5b, the pull-down reset module 7 includes a sixteenth transistor T16, a seventeenth transistor T17, a eighteenth transistor T18 and a nineteenth transistor T19. The transistors are shown in FIG. 5a as N-type transistors, and in FIG. 5b as P-type transistors.

The sixteenth transistor T16 has a gate connected to the input terminal IN, a source connected to the second node PD1, and a drain connected to the reference signal terminal Vref. The seventeenth transistor T17 has a gate connected to the input terminal IN, a source connected to the third node PD2, and a drain connected to the reference signal terminal Vref. The eighteenth transistor T18 has a gate connected to the input terminal IN, a source connected to the fourth node PD_CN1, and a drain connected to the reference signal terminal Vref. The nineteenth transistor T19 has a gate connected to the input terminal IN, a source connected to the fifth node PD_CN2, and a drain connected to the reference signal terminal Vref.

In embodiments, for simplification of the fabrication process, the transistors T1 to T20 are generally fabricated as having the same type (either a P-type or an N-type), although this is not necessary. In an embodiment where the input signal, the reset signal and the control signals are active-high, the transistors T1 to T20 are fabricated as N-type transistors. In an embodiment where the input signal, the reset signal and the control signals are active-low, the transistors T1 to T20 are fabricated as P-type transistors. Upon applied to the gate of a transistor, the “active” signal enables the transistor to be turned on.

In embodiments, the transistors T1 to T20 may be thin film transistors (TFTs) or metal oxide semiconductor field effect transistors (MOSFETs). These transistors are generally fabricated such that their respective sources and drains may be used interchangeably.

Operations of the example circuits of the shift registers shown in FIGS. 4a and 5a are described below respectively. In these two example circuits, all the transistors are N-type transistors. The gate voltage for turning on the N-type transistors is a high level voltage, and the gate voltage for turning off the N-type transistors is a low level voltage.

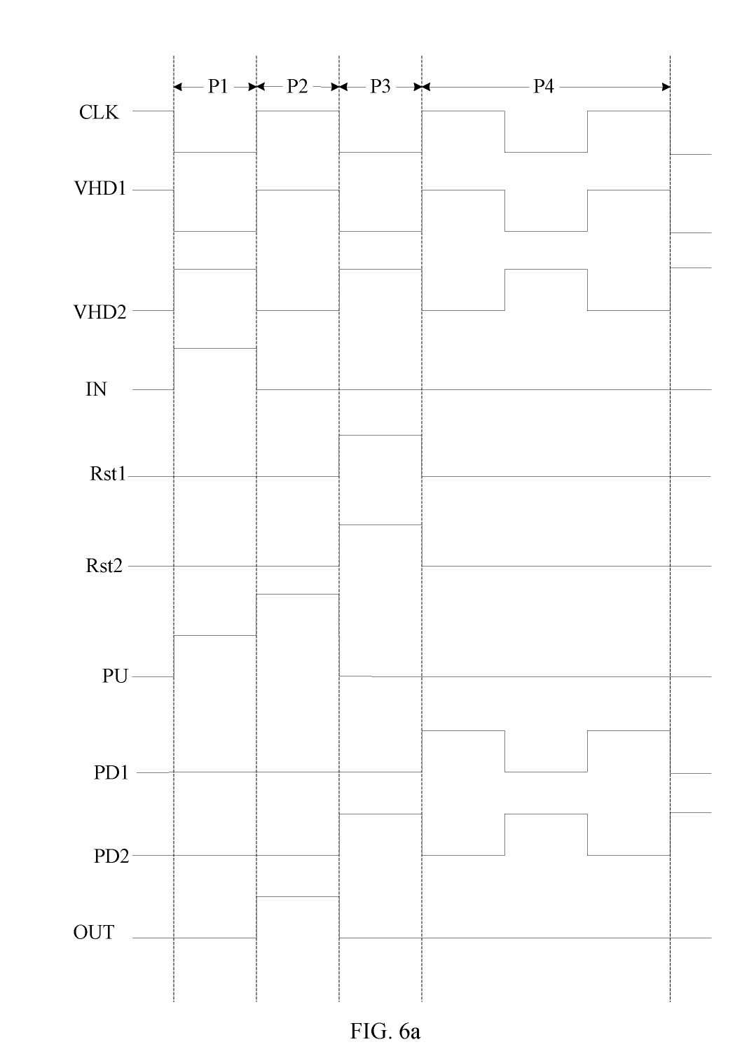

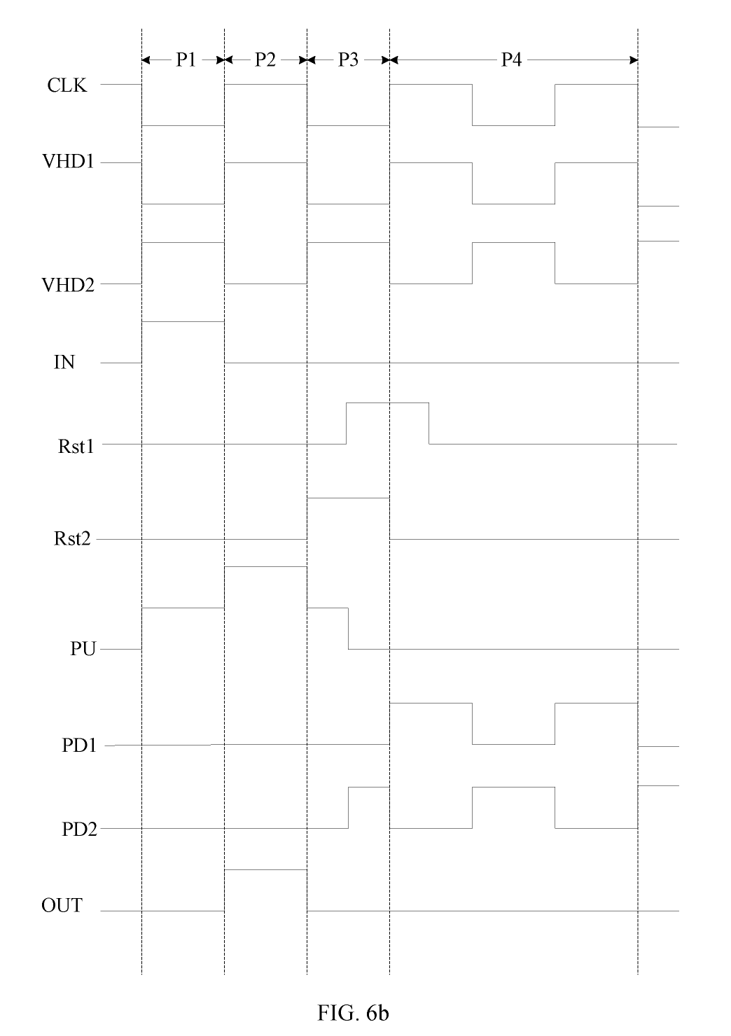

FIG. 6a is a timing diagram of the shift register circuit of FIG. 4a. The input signal from the input terminal IN is an active-high signal. The first reset signal and the second reset signal may be the same signal, namely, the first reset signal terminal Rst1 and the second reset signal terminal Rst2 are connected to each other. The periods of the first control signal and the second control signal are the same as that of the clock signal from the clock signal terminal CLK. The reference signal (not shown) from the reference signal terminal Vref is an active-low signal.

The timing diagram of FIG. 6a includes four phases P1, P2, P3 and P4.

At phase P1, as Rst1 and Rst2 are at a low level, the second transistor T2 and the twentieth transistor T20 are turned off. As IN is at a high level, the first transistor T1 is turned on. The high level of the input signal is transferred to the first node PU through the first transistor T1. The capacitor C1 is charged, and causes the third transistor T3, the sixth transistor T6, the seventh transistor T7, the twelfth transistor T12 and the thirteenth transistor T13 to turn on. The low level of the reference signal is transferred to the fourth node PD_CN1 through the sixth transistor T6, and to the fifth node PD_CN2 through the twelfth transistor T12. As VHD1 is at a low level, the fourth transistor T4 is turned off. The level of the fourth node PD_CN1 is a low level, and the fifth transistor T5 is turned off. The low level of the reference signal is transferred to the second node PD1 through the seventh transistor T7, so the eighth transistor T8 and the ninth transistor T9 are turned off. As VHD2 is at a high level, the tenth transistor T10 is turned on. Due to a design of the width-to-length ratio of the tenth transistor T10 and the twelfth transistor T12, the level of the fifth node PD_CN2 is a low level and the eleventh transistor T11 is turned off. The low level of the reference signal is transferred to the third node PD2 through the thirteenth transistor

T13, so the fourteenth transistor T14 and the fifteenth transistor T15 are turned off. The low level of the clock signal is transferred to the output terminal OUT through the third transistor T3.

At phase P2, as Rst1 and Rst2 remain at a low level, the second transistor T2 and the twentieth transistor T20 remain turned off. As IN becomes at a low level, the first transistor T1 becomes turned off. CLK becomes at a high level, such that the level of the first node PU is further pulled up due to the bootstrap of the capacitor C1. The third transistor T3, the sixth transistor T6, the seventh transistor T7, the twelfth transistor T12 and the thirteenth transistor T13 remain turned on. The low level of the reference signal is transferred to the fourth node PD_CN1 through the sixth transistor T6, and to the fifth node PD_CN2 through the twelfth transistor T12. As VHD1 is at a high level, the fourth transistor T4 becomes turned on. Due to a design of the width-to-length ratio of the fourth transistor T4 and the sixth transistor T6, the level of the fourth node PD_CN1 remains at a low level and the fifth transistor T5 remains turned off. The low level of the reference signal is transferred to the second node PD1 through the seventh transistor T7, so the eighth transistor T8 and the ninth transistor T9 remain turned off. As VHD2 is at a low level, the tenth transistor T10 becomes turned off, the level of the fifth node PD_CN2 remains at a low level, and the eleventh transistor T11 remains turned off. The low level of the reference signal is transferred to the third node PD2 through the thirteenth transistor T13, so the fourteenth transistor T14 and the fifteenth transistor T15 remain turned off. The high level of the clock signal is transferred to the output terminal OUT through the third transistor T3.

At phase P3, as Rst1 and Rst2 become at a high level, the second transistor T2 and the twentieth transistor T20 become turned on. As IN remains at a low level, the first transistor T1 remains turned off. The low level of the reference signal is transferred to the output terminal OUT through the twentieth transistor T20, and to the first node PU through the second transistor T2. The capacitor C1 discharges, and causes the third transistor T3, the sixth transistor T6, the seventh transistor T7, the twelfth transistor T12 and the thirteenth transistor T13 to become turned off. As VHD1 is at a low level, the fourth transistor T4 is turned off, the level of the fourth node PD_CN1 remains at a low level, the fifth transistor T5 remains turned off, the level of the second node PD1 remains at a low level, and the eighth transistor T8 and the ninth transistor T9 remain turned off. As VHD2 is at a high level, the tenth transistor T10 becomes turned on, such that the high level of the second control signal is transferred to the fifth node PD_CN2 through the tenth transistor T10, and the eleventh transistor T11 becomes turned on. The level of the third node PD2 becomes at a high level, so the third node PD2 controls the fourteenth transistor T14 and the fifteenth transistor T15 to become turned on. The low level of the reference signal is transferred to the first node PU through the fourteenth transistor T14, further ensuring that the level of the first node PU is a low level. The low level of the reference signal is also transferred to the output terminal OUT through the fifteenth transistor T15, further ensuring that the level of the output terminal is a low level.

At phase P4, as Rst1 and Rst2 become at a low level, the second transistor T2 and the twentieth transistor T20 become turned off. As IN remains at a low level, the first transistor T1 remains turned off.

When VHD1 is at a high level, the fourth transistor T4 is turned on, such that the high level of the first control signal is transferred to the fourth node PD_CN1 through the fourth transistor T4. The fifth transistor T5 is turned on such that the level of the second node PD1 is a high level and the eighth transistor T8 and the ninth transistor T9 is turned on. The low level of the reference signal is transferred to the first node PU through the eighth transistor T8. The capacitor C1 discharges, and causes the third transistor T3, the sixth transistor T6, the seventh transistor T7, the twelfth transistor T12 and the thirteenth transistor T13 to remain turned off. As the third transistor T3 is turned off, CLK does not affect the output terminal OUT whether it is at a high level or a low level. The low level of the reference signal is transferred to the output terminal OUT through the ninth transistor T9. When VHD1 is at the high level, VHD2 is at a low level, and the tenth transistor T10 to the fifteenth transistor T15 are all turned off.

When VHD2 is at a high level, the tenth transistor T10 becomes turned on, such that the high level of the second control signal is transferred to the fifth node PD_CN2 through the tenth transistor T10. The eleventh transistor T11 is turned on, such that the level of the third node PD2 is a high level and the fourteenth transistor T14 and the fifteenth transistor T15 are turned on. The low level of the reference signal is transferred to the first node PU through the fourteenth transistor T14, ensuring that the level of the first node PU is a low level. The low level of the reference signal is also transferred to the output terminal OUT through the fifteenth transistor T15, ensuring that the level of the output terminal OUT is a low level. When VHD2 is at the high level, VHD1 is at a low level, and the fourth transistor T4 to the ninth transistor T9 are all turned off.

Thereafter, the shift register repeats the operations as described above until it receives a next frame of input signals. When VHD1 is at a high level, the fourth transistor T4, the fifth transistor T5, the eighth transistor T8 and the ninth transistor T9 are turned on; when VHD2 is at a high level, the tenth transistor T10, the eleventh transistor T11, the fourteenth transistor T14 and the fifteenth transistor T15 are turned on. In this way, these two groups of transistors are turned on alternately, rather than kept turned on during phase P4. This can prolong the service life of the individual transistors.

FIG. 6b is a timing diagram of the shift register circuit of FIG. 5a. The input signal from the input terminal IN is an active-high signal. The first reset signal from the first reset signal terminal Rst1 is delayed by 0 to ½ clock period (¼ clock period in the example of FIG. 6b) with respect to the second reset signal from the second reset signal terminal Rst2. The periods of the first control signal and the second control signal are the same as that of the clock signal from the clock signal terminal CLK. The reference signal (not shown) from the reference signal terminal Vref is an active-low signal.

The timing diagram of FIG. 6b includes four phases P1, P2, P3 and P4.

At phase P1, as Rst1 and Rst2 are at a low level, the second transistor T2 and the twentieth transistor T20 are turned off. As IN is at a high level, the sixteenth transistor T16 to the nineteenth transistor T19 are turned on. The low level of the reference signal is transferred to the second node PD1, the third node PD2, the fourth node PD_CN1 and the fifth node PD_CN2. The first transistor T1 is turned on, and the high level of the input signal is transferred to the first node PU through the first transistor T1. The capacitor C1 is charged, and causes the third transistor T3, the sixth transistor T6, the seventh transistor T7, the twelfth transistor T12 and the thirteenth transistor T13 to turn on. The low level of the reference signal is transferred to the fourth node PD_CN1 through the sixth transistor T6, and to the fifth node PD_CN2 through the twelfth transistor T12. As VHD1 is at a low level, the fourth transistor T4 is turned off, the level of the fourth node PD_CN1 is a low level, and the fifth transistor T5 is turned off. The low level of the reference signal is transferred to the second node PD1 through the seventh transistor T7, so the eighth transistor T8 and the ninth transistor T9 are turned off. As VHD2 is at a high level, the tenth transistor T10 is turned on. Due to a design of the width-to-length ratio of the tenth transistor T10 and the twelfth transistor T12, the level of the fifth node PD_CN2 is a low level, such that the eleventh transistor T11 is turned off. The low level of the reference signal is transferred to the third node PD2 through the thirteenth transistor T13, so the fourteenth transistor T14 and the fifteenth transistor T15 are turned off. The low level of the clock signal is transferred to the output terminal OUT through the third transistor T3.

At phase P2, as Rst1 and Rst2 remain at a low level, the second transistor T2 and the twentieth transistor T20 remain turned off. As IN becomes at a low level, the first transistor T1 becomes turned off and the sixteenth transistor T16 to the nineteenth transistor T19 also become turned off. CLK becomes at a high level, such that the level of the first node PU is further pulled up due to the bootstrap of the capacitor C1. The third transistor T3, the sixth transistor T6, the seventh transistor T7, the twelfth transistor T12 and the thirteenth transistor T13 remain turned on. The low level of the reference signal is transferred to the fourth node PD_CN1 through the sixth transistor T6, and to the fifth node PD_CN2 through the twelfth transistor T12. As VHD1 is at a high level, the fourth transistor T4 becomes turned on. Due to a design of the width-to-length ratio of the fourth transistor T4 and the sixth transistor T6, the level of the fourth node PD_CN1 remains at a low level such that the fifth transistor T5 remains turned off. The low level of the reference signal is transferred to the second node PD1 through the seventh transistor T7, so the eighth transistor T8 and the ninth transistor T9 remain turned off. As VHD2 is at a low level, the tenth transistor T10 becomes turned off. The level of the fifth node PD_CN2 remains at a low level, and the eleventh transistor T11 remains turned off. The low level of the reference signal is transferred to the third node PD2 through the thirteenth transistor T13, so the fourteenth transistor T14 and the fifteenth transistor T15 remain turned off. The high level of the clock signal is transferred to the output terminal OUT through the third transistor T3.

At phase P3, as Rst2 becomes at a high level, the twentieth transistor T20 becomes turned on. The low level of the reference signal is transferred to the output terminal OUT through the twentieth transistor T20. As IN remains at a low level, the first transistor T1 remains turned off, and the sixteenth transistor T16 to the nineteenth transistor T19 also remain turned off.

During a time period when Rst1 remains at a low level, the second transistor T2 is turned off. The clock signal becomes at a low level, such that the level of the first node PU is pulled down due to the bootstrap of the capacitor C1, but is still a high level. The third transistor T3, the sixth transistor T6, the seventh transistor T7, the twelfth transistor T12 and the thirteenth transistor T13 are turned on. The low level of the reference signal is transferred to the fourth node PD_CN1 through the sixth transistor T6, and to the fifth node PD_CN2 through the twelfth transistor T12. As VHD1 is at a low level, the fourth transistor T4 is turned off. The level of the fourth node PD_CN1 is a low level, the fifth transistor T5 remains turned off, the level of the second node PD1 remains at a low level, and the eighth transistor T8 and the ninth transistor T9 remain turned off. As VHD2 is at a high level, the tenth transistor T10 is turned on. Due to a design of the width-to-length ratio of the tenth transistor T10 and the twelfth transistor T12, the level of the fifth node PD_CN2 is a low level, and the eleventh transistor T11 is turned off. The low level of the reference signal is transferred to the third node PD2 through the thirteenth transistor T13, so the fourteenth transistor T14 and the fifteenth transistor T15 are turned off. The low level of the clock signal is transferred to the output terminal OUT through the third transistor T3, further ensuring that the level of the output terminal OUT is a low level.

During a time period when Rst1 becomes at a high level, the second transistor T2 becomes turned on. The low level of the reference signal is transferred to the first node PU through the second transistor T2. The capacitor C1 discharges, and causes the third transistor T3, the sixth transistor T6, the seventh transistor T7, the twelfth transistor T12 and the thirteenth transistor T13 to become turned off. As VHD1 is at a low level, the fourth transistor T4 is turned off. The level of the fourth node PD_CN1 remains at a low level, and the fifth transistor T5 remains turned off. The level of the second node PD1 remains at a low level, and the eighth transistor T8 and the ninth transistor T9 remain turned off. As VHD2 is at a high level, the tenth transistor T10 becomes turned on. The high level of the second control signal is transferred to the fifth node PD_CN2 through the tenth transistor T10, such that the eleventh transistor T11 becomes turned on. The level of the third node PD2 becomes at a high level, such that the fourteenth transistor T14 and the fifteenth transistor T15 become turned on. The low level of the reference signal is transferred to the first node PU through the fourteenth transistor T14, further ensuring that the level of the first node PU is a low level. The low level of the reference signal is also transferred to the output terminal OUT through the fifteenth transistor T15, further ensuring that the level of the output terminal OUT is a low level.

The delay of the first reset signal with respect to the second reset signal enables the level of the output terminal OUT to be pulled down to a low level more quickly. As such, the reset time of the output terminal OUT is reduced, and thus the driving capability of the shift register is improved.

At phase P4, as Rst2 becomes at a low level, the twentieth transistor T20 becomes turned off. As IN remains at a low level, the first transistor T1 remains turned off.

During a time period when Rst1 remains at a high level, the second transistor T2 is turned on. The low level of the reference signal is transferred to the first node PU through the second transistor T2, such that the level of the first node PU remains at a low level. The capacitor C1 continues to discharge, and causes the third transistor T3, the sixth transistor T6, the seventh transistor T7, the twelfth transistor T12 and the thirteenth transistor T13 to remain turned off. As the third transistor T3 is turned off, CLK does not affect the output terminal OUT whether it is at a high level or a low level. When Rst1 becomes at a low level, the second transistor T2 is turned off, and the level of the first node PU remains at a low level.

When VHD1 is at a high level, the fourth transistor T4 is turned on, such that the high level of the first control signal is transferred to the fourth node PD_CN1 through the fourth transistor T4. The fifth transistor T5 is turned on such that the level of the second node PD1 is a high level and the eighth transistor T8 and the ninth transistor T9 is turned on. The low level of the reference signal is transferred to the first node PU through the eighth transistor T8. The low level of the reference signal is also transferred to the output terminal OUT through the ninth transistor T9, causing the level of the output terminal OUT to remain at a low level. When VHD1 is at the high level, VHD2 is at a low level, and the tenth transistor T10 to the fifteenth transistor T15 are all turned off.

When VHD2 is at a high level, the tenth transistor T10 becomes turned on, such that the high level of the second control signal is transferred to the fifth node PD_CN2 through the tenth transistor T10. The eleventh transistor T11 is turned on, such that the level of the third node PD2 is a high level and the fourteenth transistor T14 and the fifteenth transistor T15 are turned on. The low level of the reference signal is transferred to the first node PU through the fourteenth transistor T14, ensuring that the level of the first node PU is a low level. The low level of the reference signal is also transferred to the output terminal OUT through the fifteenth transistor T15, ensuring that the level of the output terminal OUT is a low level. When VHD2 is at the high level, VHD1 is at a low level, and the fourth transistor T4 to the ninth transistor T9 are all turned off.

Thereafter, the shift register repeats the operations as described above until it receives a next frame of input signals. When VHD1 is at a high level, the fourth transistor T4, the fifth transistor T5, the eighth transistor T8 and the ninth transistor T9 are turned on; when VHD2 is at a high level, the tenth transistor T10, the eleventh transistor T11, the fourteenth transistor T14 and the fifteenth transistor T15 are turned on. In this way, these two groups of transistors are turned on alternately, rather than kept turned on during phase P4. This can prolong the service life of the individual transistors.

The operations of the shift register circuit formed by N-type transistors have been described above. For a shift register circuit formed by P-type transistors (e.g., as shown in FIGS. 4b and 5b), the operations are similar. As is known, the gate voltage for turning on the P-type transistors is a low level voltage, and the gate voltage for turning off the P-type transistors is a high level voltage.

In the embodiments as described above, the periods of the first control signal and the second control signal are the same as that of the clock signal. However, other embodiments are possible. For example, the periods of the first control signal and the second control signal may be one frame period or even hundreds of frame periods.

A gate driver circuit may be achieved by cascading a plurality of the shift registers as described above. Depending on different design purposes, the plurality of shift registers can be cascaded together in different manners.

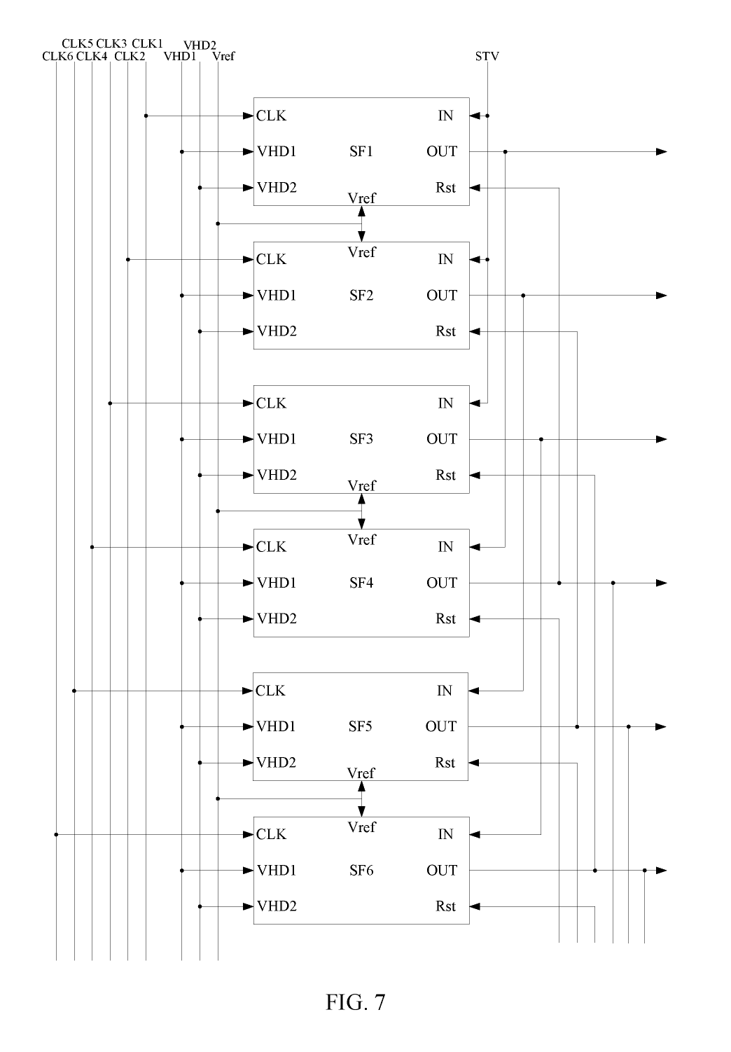

FIG. 7 is a schematic diagram of a gate driver circuit according to an embodiment of the present disclosure. In this embodiment, each shift register has a clock terminal CLK, a first control signal terminal VHD1, a second control signal terminal VHD2, a reference signal terminal Vref, an input terminal IN, an output terminal OUT, a first reset signal terminal Rst1 and a second reset signal terminal Rst2. In particular, the first reset signal terminal Rst1 and the second reset signal terminal Rst2 are connected to each other and are shown as a single common terminal “Rst”.

In the gate driving circuit as shown in FIG. 7, the output terminal OUT of the n-th shift register is connected to the input terminal IN of the (n+m)th shift register, and the output terminal OUT of the n-th shift register is connected to the common terminal Rst (i.e., the first reset signal terminal Rst1 and second reset signal terminal Rst2) of the (n−m)th shift register, wherein m is an integer larger than or equal to 1, and n is an integer larger than m. FIG. 7 shows a connection of the first six shift registers SF1, SF2, SF3, SF4, SF5, SF6 when m=3, wherein the input terminals IN of the shift registers SF1, SF2, SF3 are supplied with a frame start signal STV as the input signal, and the clock signal terminals CLK of the shift registers SF1, SF2, SF3, SF4, SF5, SF6 are supplied with respective clock signals CLK1, CLK2, CLK3, CLK4, CLK5, CLK6.

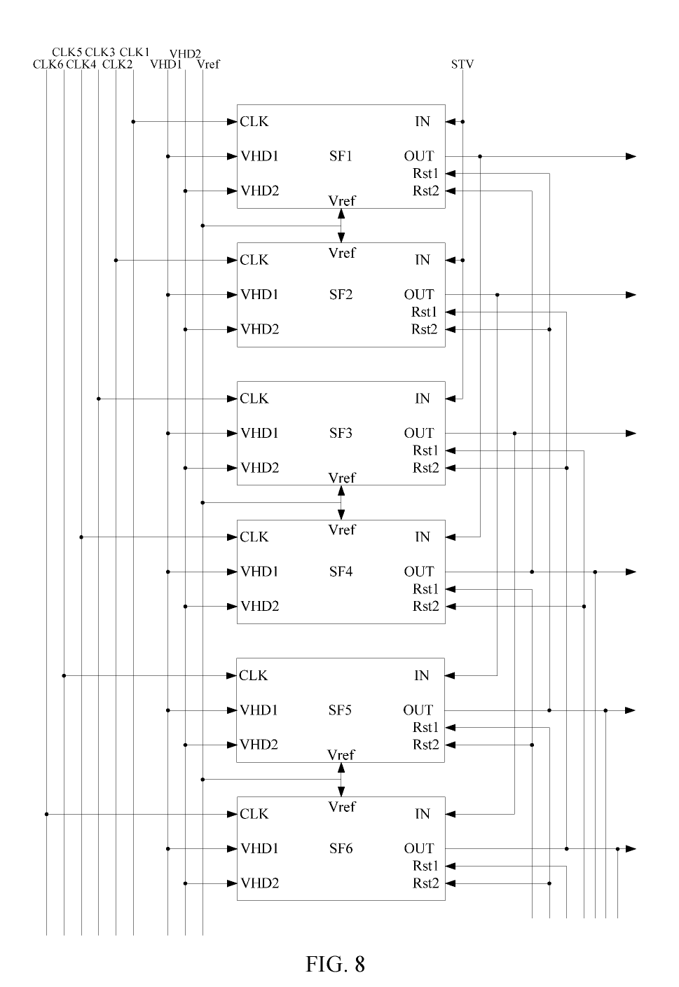

FIG. 8 is another schematic diagram of a gate driver circuit according to an embodiment of the present disclosure. In this embodiment, the first reset signal terminal Rst1 and the second reset signal terminal Rst2 of each shift register are separate terminals.

In the gate driving circuit as shown in FIG. 8, the output terminal OUT of the n-th shift register is connected to the input terminal IN of the (n+m)th shift register, and the output terminal OUT of the n-th shift register is connected to the first reset signal terminal Rst1 of the (n−m−1)th shift register and the second reset signal terminal Rst2 of the (n−m)th shift register, wherein m is an integer larger than or equal to 1, and n is an integer larger than m. FIG. 8 shows a connection of the first six shift registers SF1, SF2, SF3, SF4, SF5, SF6 when m=3, wherein the input terminals IN of the shift registers SF1, SF2, SF3 are supplied with a frame start signal STV as the input signal, and the clock signal terminals CLK of the shift registers SF1, SF2, SF3, SF4, SF5, SF6 are supplied with respective clock signals CLK1, CLK2, CLK3, CLK4, CLK5, CLK6.

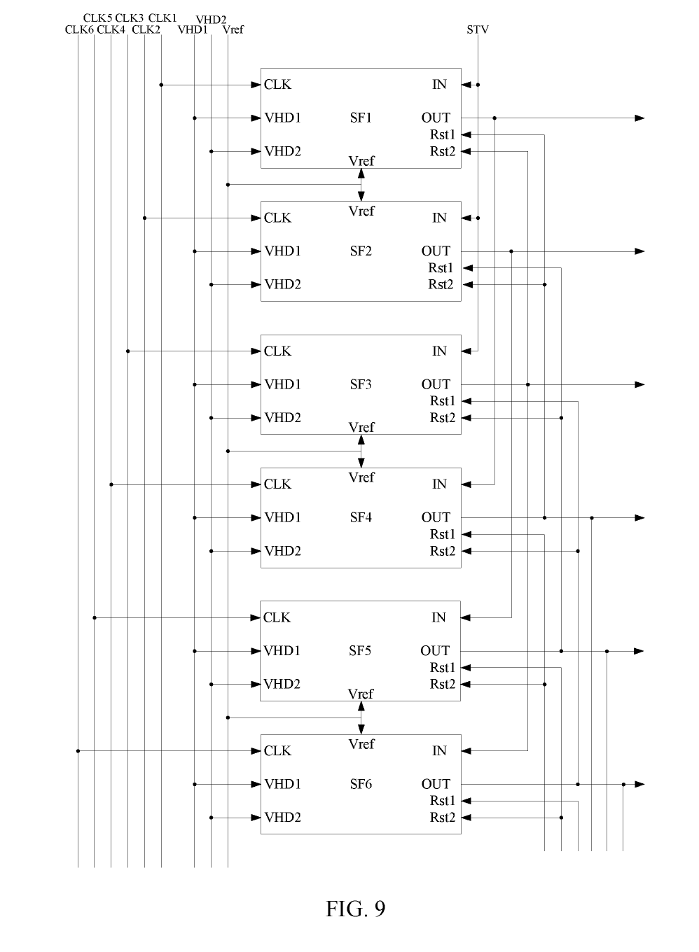

FIG. 9 is yet another schematic diagram of a gate driver circuit according to an embodiment of the present disclosure. In this embodiment, the first reset signal terminal Rst1 and the second reset signal terminal Rst2 of each shift register are separate terminals.

In the gate driving circuit as shown in FIG. 9, the output terminal OUT of the n-th shift register is connected to the input terminal IN of the (n+m)th shift register, and the output terminal OUT of the n-th shift register is connected to the first reset signal terminal Rst1 of the (n−m)th shift register and the second reset signal terminal Rst2 of the (n−m+1)th shift register, wherein m is an integer larger than or equal to 1, and n is an integer larger than m. FIG. 9 shows a connection of the first six shift registers SF1, SF2, SF3, SF4, SF5, SF6 when m=3, wherein the input terminals IN of the shift registers SF1, SF2, SF3 are supplied with a frame start signal STV as the input signal, and the clock signal terminals CLK of the shift registers SF1, SF2, SF3, SF4, SF5, SF6 are supplied with respective clock signals CLK1, CLK2, CLK3, CLK4, CLK5, CLK6.

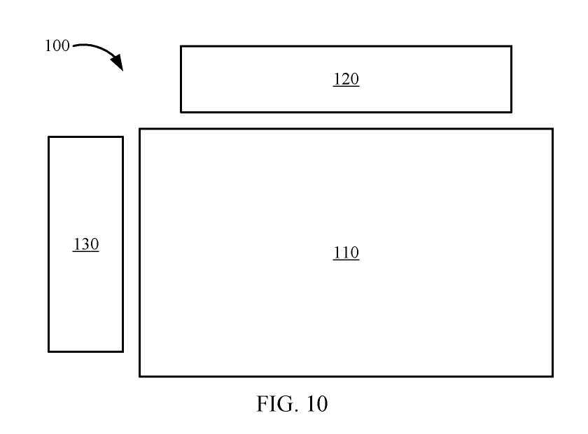

FIG. 10 is a schematic diagram of a display apparatus according to an embodiment of the present disclosure. Referring to FIG. 10, the display apparatus 100 includes a display panel 110 for displaying images, a data driver circuit 120 for supplying data voltages to the display panel 110, and a gate driver circuit 130 for supplying gate voltages to the display panel 110. The gate driver circuit 130 may be any one of the gate driver circuits as described in the above embodiments, the detailed description of which is thus omitted here.

Examples of the display panel 110 include a liquid crystal display panel and an organic light-emitting diode display panel. In some embodiments, the data driver circuit 120 and the gate driver circuit 130 may be integrated on the display panel 110. In some embodiments, at least one of the data driver circuit 120 and the gate driver circuit 130 may form a separate chip.

According to embodiments of the present disclosure, the active levels of the first control signal and the second control signal occur alternately, allowing part of the components of the first pull-down module and the second pull-down module to operate alternately, and thus reducing their respective actual operating time. This can prolong the working life of the shift register.

Various modifications and variations to this disclosure may be made by those skilled in the art without departing from the spirit and scope of the present disclosure. Thus, if the modifications and variations fall within the scope of the appended claims and equivalents thereof, the present disclosure is intended to encompass these modifications and variations.

1. A shift register comprising:
an input module configured to set a level of a first node to a first level in response to an active level of an input signal from an input terminal;
an output module configured to supply a clock signal from a clock signal terminal to an output terminal in response to the level of the first node being the first level;
a first reset module configured to supply a reference signal from a reference signal terminal to the first node in response to an active level of a first reset signal from a first reset signal terminal;
a first pull-down module configured to supply the reference signal from the reference signal terminal to a second node in response to the level of the first node being the first level, and to set a level of the second node to the first level and supply the reference signal from the reference signal terminal to the first node and the output terminal in response to an active level of a first control signal from a first control signal terminal; and
a second pull-down module configured to supply the reference signal from the reference signal terminal to a third node in response to the level of the first node being the first level, and to set a level of the third node to the first level and supply the reference signal from the reference signal terminal to the first node and the output terminal in response to an active level of a second control signal from a second control signal terminal, wherein the active levels of the first control signal and the second control signal occur alternately.

2. The shift register of claim 1, wherein the input module comprises a first transistor having a gate and a source jointly connected to the input terminal, and a drain connected to the first node.

3. The shift register of claim 1, wherein the first reset module comprises a second transistor having a gate connected to the first reset signal terminal, a source connected to first node, and a drain connected to the reference signal terminal.

4. The shift register of claim 1, wherein the output module comprises a third transistor having a gate connected to the first node, a source connected to the clock signal terminal, and a drain connected to the output terminal.

5. The shift register of claim 4, wherein the output module further comprises a capacitor connected between the gate and drain of the third transistor.

6. The shift register of claim 1, wherein the first pull-down module comprises:
a fourth transistor having a gate and a source jointly connected to the first control signal terminal, and a drain connected to a fourth node;
a fifth transistor having a gate connected to the fourth node, a source connected to the first control signal terminal, and a drain connected to the second node;
a sixth transistor having a gate connected to the first node, a source connected to the fourth node, and a drain connected to the reference signal terminal;
a seventh transistor having a gate connected to the first node, a source connected to the second node, and a drain connected to the reference signal terminal;
an eighth transistor having a gate connected to the second node, a source connected to the first node, and drain connected to the reference signal terminal; and
a ninth transistor having a gate connected to the second node, a source connected to the output terminal, and a drain connected to the reference signal terminal.

7. The shift register of claim 6, wherein the second pull-down module comprises:
a tenth transistor having a gate and a source jointly connected to the second control signal terminal, and a drain connected to a fifth node;
an eleventh transistor having a gate connected to the fifth node, a source connected to the second control signal terminal, and a drain connected to the third node;
a twelfth transistor having a gate connected to the first node, a source connected to the fifth node, and a drain connected to the reference signal terminal;
a thirteenth transistor having a gate connected to the first node, a source connected to the third node, and a drain connected to the reference signal terminal;
a fourteenth transistor having a gate connected to the third node, a source connected to the first node, and a drain connected to the reference signal terminal; and
a fifteenth transistor having a gate connected to the third node, a source connected to the output terminal, and a drain connected to the reference signal terminal.

8. The shift register of claim 7, further comprising a pull-down reset module configured to supply the reference signal from the reference signal terminal to the second node, the third node, the fourth node and the fifth node in response to the active level of the input signal from the input terminal.

9. The shift register of claim 8, wherein the pull-down reset module comprises:
a sixteenth transistor having a gate connected to the input terminal, a source connected to the second node, and a drain connected to the reference signal terminal;
a seventeenth transistor having a gate connected to the input terminal, a source connected to the third node, and a drain connected to the reference signal terminal;
an eighteenth transistor having a gate connected to the input terminal, a source connected to the fourth node, and a drain connected to the reference signal terminal; and
a nineteenth transistor having a gate connected to the input terminal, a source connected to the fifth node, and a drain connected to the reference signal terminal.

10. The shift register of any one of claims 1 9claim 1, further comprising a second reset module configured to supply the reference signal from the reference signal terminal to the output terminal in response to an active level of a second reset signal from a second reset signal terminal.

11. The shift register of claim 10, wherein the second reset module comprises a twentieth transistor having a gate connected to the second reset signal terminal, a source connected to the output terminal, and a drain connected to the reference signal terminal.

12. The shift register of claim 10, wherein the first reset signal terminal and the second reset signal terminal are connected to each other.

13. The shift register of claim 10, wherein the first reset signal is delayed by 0 to ½ clock period with respect to the second reset signal.

14. A gate driver circuit comprising a plurality of cascaded shift registers as recited in claim 12, each of the shift registers having a respective output terminal, an input terminal, a first reset signal terminal and a second reset signal terminal, wherein the output terminal of the n-th shift register is connected to the input terminal of the (n+m)th shift register, and the output terminal of the n-th shift register is connected to the first reset signal terminal and second reset signal terminal of the (n−m)th shift register, wherein m is an integer larger than or equal to 1, and n is an integer larger than m.

15. A gate driver circuit comprising a plurality of cascaded shift registers as recited in claim 13, each of the shift registers having a respective output terminal, an input terminal, a first reset signal terminal and a second reset signal terminal, wherein the output terminal of the n-th shift register is connected to the input terminal of the (n+m)th shift register, and the output terminal of the n-th shift register is connected to the first reset signal terminal of the (n−m−1)th shift register and the second reset signal terminal of the (n−m)th shift register, wherein m is an integer larger than or equal to 1, and n is an integer larger than m.

16. A gate driver circuit comprising a plurality of cascaded shift registers as recited in claim 13, each of the shift registers having a respective output terminal, an input terminal, a first reset signal terminal and a second reset signal terminal, wherein the output terminal of the n-th shift register is connected to the input terminal of the (n+m)th shift register, and the output terminal of the n-th shift register is connected to the first reset signal terminal of the (n−m)th shift register and the second reset signal terminal of the (n−m+1)th shift register, wherein m is an integer larger than 1, and n is an integer larger than m.

17. A display apparatus comprising the gate driver circuit of claim 14.

18. A display apparatus comprising the gate driver circuit of claim 15.

19. A display apparatus comprising the gate driver circuit of claim 16.
